(19) United States
(12) Patent Application Publication
(10) Pub. No.: US 2014/0365388 A1
(43) Pub. Date: Dec. 11, 2014

(54) PROTOCOL MANAGEMENT SYSTEM AND METHODS FOR LIVESTOCK OPERATIONS

(71) Applicant: Mark Joseph VAN DER LIST, Davis, CA (US)

(72) Inventor: Mark Joseph VAN DER LIST, Davis, CA (US)

(73) Assignee: BOEHRINGER INGELHEIM VETMEDICA, INC., Saint Joseph, MO (US)

(21) Appl. No.: 14/294,513

(22) Filed: Jun. 3, 2014

Related U.S. Application Data
(60) Provisional application No. 61/831,415, filed on Jun. 5, 2013.

(51) Int. Cl. G06Q 30/00; G06Q 50/02

(52) U.S. Cl. CPC G06Q 30/018; G06Q 50/02
USPC 705/317

(57) ABSTRACT

The present disclosure provides systems and methods for developing and managing a protocol for use in a livestock operation. The method includes receiving, at a computing platform, input from a user, generating, using the computing platform, the protocol based on the user input, wherein the protocol includes at least one activity period including at least one action, and distributing the protocol to at least one end user.

### FIELD OF THE INVENTION

The present invention relates to a protocol management system. More particularly, the present invention relates to a protocol management system used to build health related protocols used in livestock operations.

### BACKGROUND OF THE RELATED ART

The use of computers for medical protocols is known. A conventional system includes a medical professional using a computer or device that displays steps to be taken in completing the protocol. The user would enter information into the computer at each step while treating a patient after being prompted by questions. This process ensures the protocol is followed. Other systems may receive information and prescribe some sort of treatment, or recommend a protocol to follow.

The conventional system applies to a doctor's office. Patients come in and indicate their symptoms to the doctor. Tests may be run and protocols followed to diagnose and treat the patient. These protocols may be standard for normal adult humans, with slight variations depending on the physiology of the patient. If the protocol is effective, then the patient most likely does not return to the doctor's office except for a follow-up appointment. The protocols may be stored on computers within the doctor's office and available for personnel within the office.

### SUMMARY OF THE INVENTION

Such protocol management schemes may not be applicable for an environment away from a conventional doctor's office, such as a farm or any place with a large animal population. In these environments, the health professional is often not directly involved in treating an illness, but has established steps to follow given a specified condition and these steps are carried out by on farm personnel. These protocols must be followed carefully in order to keep the livestock free of disease (vaccination protocols) and to ensure the proper treatment of ill animals occurs (treatment protocols) (hereinafter collectively known as protocols). In addition, because products from livestock end up in the human food chain, it is very important that no violative residues arise from treatment. For example, a farm may implement a protocol for utilizing antibiotics on animals targeted for consumption. In some embodiments, antibiotic residues from the treatment must be below a government mandated level before the animal is slaughtered, or the resulting produce will be deemed violative.

Thus, the disclosed embodiments include a protocol management system and associated methods that allow a user to develop or build protocols for a farming environment, and then share these protocols with similar farms. For example, a protocol may be built for a farm having cows that does not apply to a farm having chickens. Thus, the protocol is unique and subject to different regulations and rules applicable to that industry, with the purpose of keeping the animals from becoming contaminated or sick. Notably, the systems and methods described herein may be applicable to all types of livestock operations and other animal operations.

Benefits of the disclosed embodiments may extend to veterinarians and livestock operations. For the veterinarian, the disclosed processes provide full documentation of protocols developed for a particular farm, with modifications and amendments recorded for later review. The developed protocols are easily managed and copied to other veterinarians or farms in the same practice. This feature reduces the amount of “trial and error” with developing protocols in those additional farms. The disclosed embodiments also provide the veterinarian improved control over how scripted drugs are used on the farm. The protocol may track use of the drugs and their effects for future consideration.

With regard to livestock operations, detailed protocols developed by the disclosed embodiments may improve the probability that treatments are effectively performed. The protocols also decrease the likelihood of a violative residue in food or dairy products sold for human consumption.

In one embodiment, the present disclosure is directed to a computer-implemented method for developing and managing a protocol for a livestock operation, the method including receiving, at a computing platform, input from a user, generating, using the computing platform, the protocol based on the user input, wherein the protocol includes at least one activity period including at least one action, and distributing the protocol to at least one end user.

In another embodiment, the present disclosure is directed to a platform for developing and managing a protocol for a livestock operation, the platform including a user interface configured to receive input from a user, a processor coupled to the user interface and configured to generate the protocol based on the user input, wherein the protocol includes at least one activity period including at least one action, and distribute the protocol to at least one end user.

The foregoing and other aspects, features, details, utilities and advantages of the present disclosure will be apparent from reading the following description and claims, and from reviewing the accompanying drawings.

### BRIEF DESCRIPTION OF THE FIGURES

The accompanying drawings are included to provide further understanding of the invention and constitute a part of the specification. The drawings listed below illustrate embodiments of the present invention and, together with the description, serve to explain the principles of the disclosed embodiments, as recited by the claims and their equivalents.

FIG. 1 illustrates a block diagram of a protocol management system according to the disclosed embodiments.

FIG. 2 illustrates a flowchart of a protocol management process according to the disclosed embodiments.

FIG. 3 illustrates a flowchart for developing a protocol for livestock operation according to the disclosed embodiments.

FIG. 4 illustrates a block diagram of a protocol according to the disclosed embodiments.

FIG. 5 illustrates a flowchart for administering a protocol according to the disclosed embodiments.

FIG. 6 illustrates an example of a treatment plan according to the disclosed embodiments.

FIG. 7 illustrates a flowchart for developing a treatment plan using a protocol according to the disclosed embodiments.

### DESCRIPTION OF THE PREFERRED EMBODIMENTS

Aspects of the present invention are disclosed in the accompanying description as enabled by the figures. Alternate embodiments of the present invention and their equivalents are devised without parting from the spirit or scope of the claims. It should be noted that like elements disclosed below or indicated by like reference numerals in the figures.

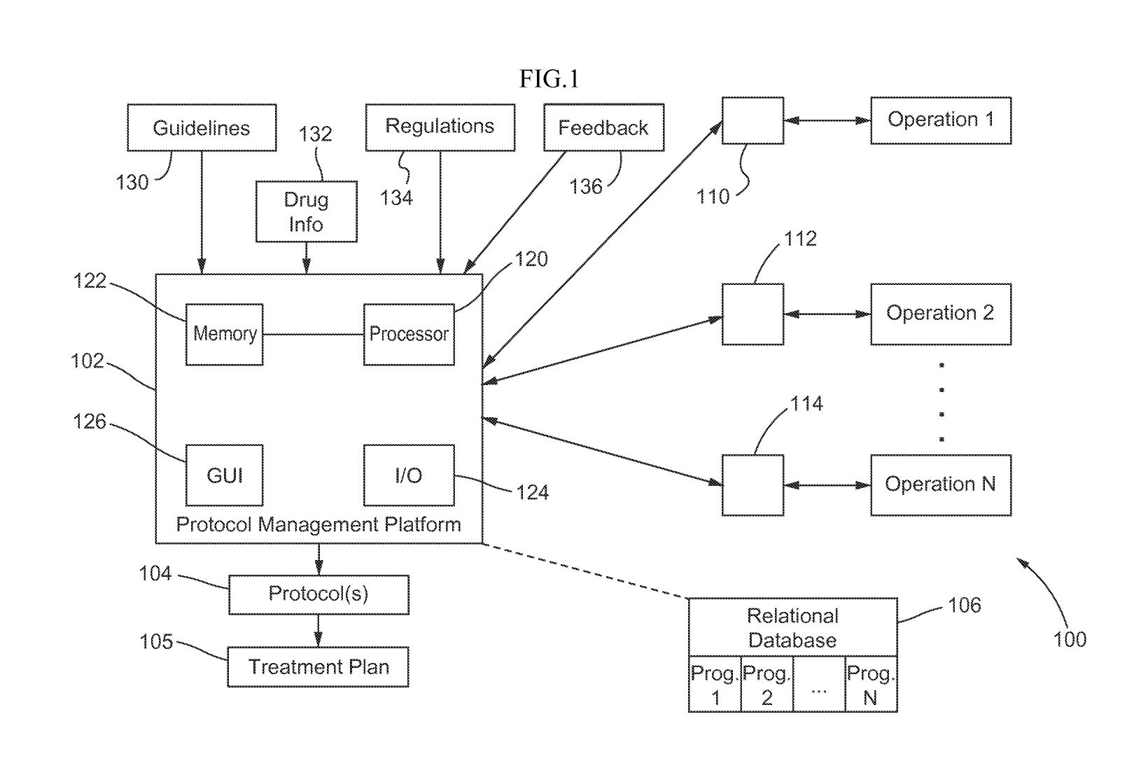

FIG. 1 depicts a block diagram of a protocol management system 100 according to the disclosed embodiments. System 100 may be implemented on a farm or in a livestock management environment where treatments are given to livestock and tracked accordingly. System 100 may be configured, preferably, over a wireless network so that different devices may exchange data through the network without being physically connected to each other. Moreover, system 100 may utilize a cloud computing configuration so that information is stored and retrieved from devices and servers over a network. End users may access cloud-based applications, such as the disclosed embodiments, through a browser or application while software configured to provide the disclosed functionality is stored on a remote server, such as relational database 106.

System 100 includes protocol management platform 102. Platform 102 controls the execution of software and flow of information on devices and applications within system 100. For example, platform 102 communicates with devices 110, 112 and 114 to implement procedures and receive feedback/results after implementation. Each device 110-114 may be associated with a station on the farm. Preferably, the devices are mobile devices, such as a tablet computer, smartphone or any wireless mobile computer. As shown in FIG. 1, the farm includes operation 1, operation 2, on up to operation N. Each operation may be associated with a station, or physical part of the farm. Thus, the farm may include any number of stations performing various operations. Each station represents a group of livestock, such as cows, pigs, chickens, and the like. In some embodiments, at least one station is a separate farm. The results of these actions for the corresponding operations may be captured and implemented in protocol(s) 104.

A user or operator using a device 110-114 takes actions according to the protocols or procedures enacted by platform 102. Thus, a veterinarian may instruct a user to perform an action via device 110 on the livestock at operation 1. The veterinarian may instruct another user to perform a different action via device 112 at operation 2. The results of these actions are then reported back to the veterinarian through platform 102.

Platform 102 includes components that enable it to execute software programs, store information, and communicate within system 100. For example, platform 102 includes processor 120 and memory 122. Processor 120 executes instructions and operates other components to provide the functionality desired by the programs. Memory 122 may store the instructions as well as any information needed to generate data or protocols. Platform 102 also may include an input/output port 124 that connects with other devices or with the network for system 100. Data is received and sent via input/output port 124. Platform 102 also includes graphical user interface (GUI) 126 to allow the display of data to the veterinarian and to receive input. GUI 126 also functions as an application programming interface that interacts within a cloud computing environment. Platform 102 also may include other components and features that are not listed here but are known to those skilled in the art.

Platform 102 is connected to relational database 106. Relational database 106 may include at least one program used to manage the veterinary protocols and standard operating procedures used at the stations on the farm. For illustrative purposes, relational database 106 includes program 1, program 2 up to program N that provides the functions disclosed below. Relational database 106 also includes a set of tables along with stored procedures. Each relational database program serves to manage veterinary protocols, such as protocol(s) 104. Each program is intended to be used by a veterinarian group with an unlimited number of members. Relational database 106 and its associated programs may be stored on a local computer along with platform 102, a handheld or mobile device, or could be located on a central or cloud server within system 100.

Relational database 106 may be configured to allow for the structure of a protocol 104 by linking fields. Each protocol may include up to N steps, as disclosed below. Each step may have up to N actions. A veterinarian is associated with N farms, and a particular farm may have N veterinarians. As used herein, N may be used to denote any number, and it is not necessarily the same number throughout. That is, the number of steps in a protocol may be different than the number of actions in a step, and the number of actions may be different from step to step. A relational database allows these relationships to be captured in storing the data. The information from the protocols is stored in tables within relational database 106. Additional information also may be stored, such as drug information, farm information, and the like. A user interface also may be built into relational database 106. This interface may be included in GUI 126, or may be its own separate interface. Protocol(s) 104 are intimately connected to the relational database 106 using the disclosed embodiments. Further, reports may be generated from the information stored within relational database 106. For example, in some embodiments, non-veterinarians may be allowed access to relational database 106 to develop and manage protocols that do not involve the user of prescription drugs.

Platform 102 may receive information used to develop protocol(s) 104. Such information may come from any source. For example, guidelines 130 and regulations 134 may include rules and parameters that must be taken into account during the development of the protocols. Government regulations are important in the monitoring of livestock, especially for residue and contamination of food and products from the livestock. Drug information 132 includes any data about the various drugs or any other item considered for use in a protocol. Feedback 136 may include results and information regarding timing and compliance. Information, such as positive or negative effects of an action, treatment data, results from implementing a protocol and the like, may be collected after using a treatment plan.

Protocol 104 may be used by platform 102, or another component within system 100, to develop a treatment plan 105. An overall treatment plan for an animal can be developed that utilizes developed and stored protocols. This treatment plan along with the employed protocols becomes part of the animal's medical record. Thus, when an animal shows a symptom of an illness, the veterinarian may prescribe the treatment plan and the protocol to use. This feature is disclosed in greater detail below. Further, protocols 104 may be utilized as broad recommendations for health issues. In some embodiments, protocols 104 are incorporated into individual or animal group case treatment plans that, when completed, become part of the health record of the animal(s).

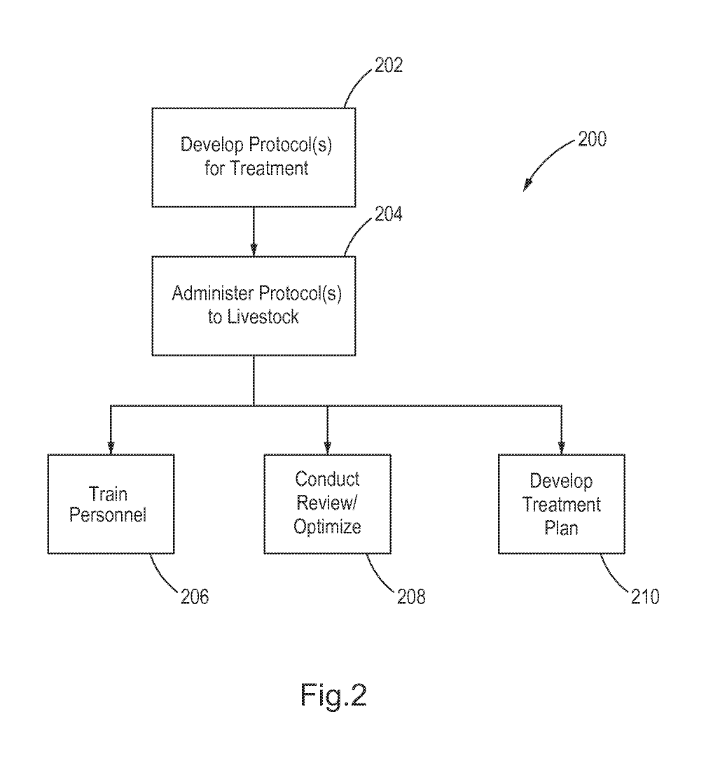

FIG. 2 depicts a flowchart 200 of a protocol management process according to the disclosed embodiments. Flowchart 200 provides an overall view of the functionality provided by the programs and components of platform 102. The steps disclosed within flowchart 200, as well as the other flowcharts described herein, may be executed using the features of system 100. The functionality, however, of the following flowcharts are not limited to the embodiments disclosed by FIG. 1, and may be implemented using a variety of configurations.

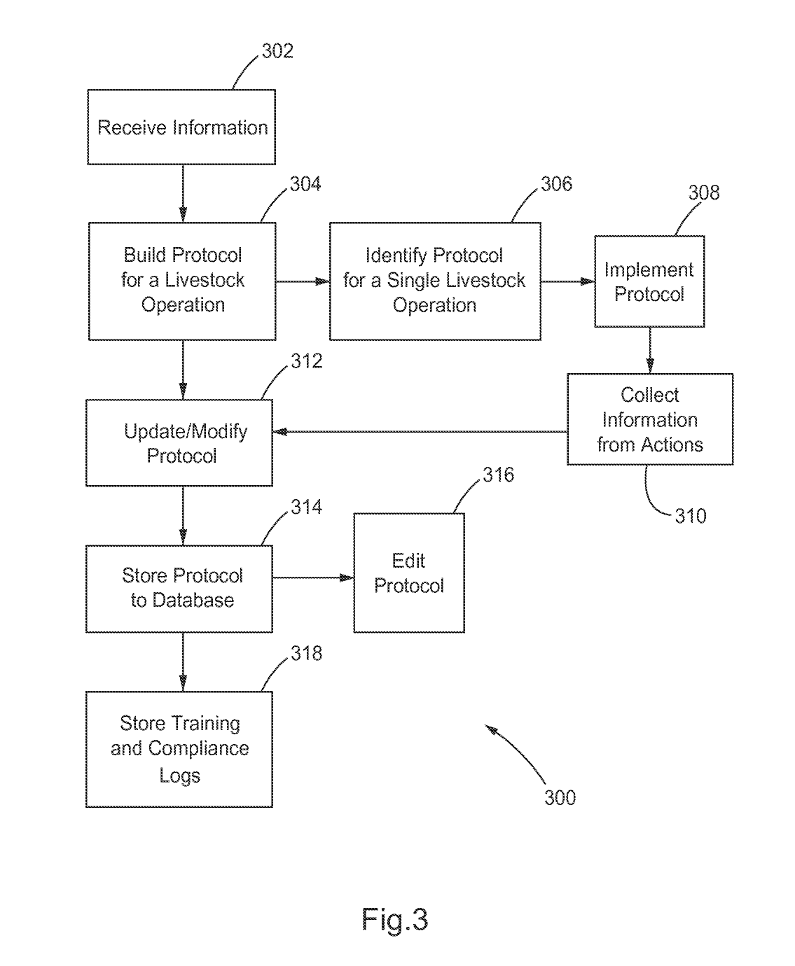

Step 202 executes by developing a protocol, or plurality of protocols, for treatment of livestock in a farming or veterinary environment. Here, a veterinarian develops a protocol in conjunction with farm or livestock management. Various goals and objectives may be identified. The protocol may be for treatment of an individual animal or a group of animals. The protocol, shown as protocol 104 above, details the proper administration and dosage of drugs to make sure proper treatment occurs and no violative residue arises within the animal. This objective is important in preventing contamination during the sale of meat or diary from the livestock after the protocol has been employed. This feature is disclosed in greater detail by FIG. 3.

Step 204 executes by administering the protocol, or protocols, to livestock within the farming environment. Protocols are given to the livestock operation management overseeing the farm, and managing the stations having operations 1 through N. These may be distributed via printed copies or, in some embodiments, through system 100 on devices 110-114. In other words, after developing a protocol, it is sent to a device for a specific operation with a group of livestock. The protocol may be sent as an electronic file, readable on the devices via a display. This feature is disclosed in greater detail below as well.

Step 206 executes by training personnel using the protocols. Management may require that users and personnel at the various operations within the farm be trained, and that this training be documented. The training may be accomplished electronically, using devices that receive a protocol. Steps are shown and performed as part of the training. Step 208 executes by conducting a review of the protocol to ensure compliance. Step 208 may execute after step 206. Further, the protocol may invoke feedback from implementing the protocol, shown as feedback 136 in FIG. 1. Step 210 may execute by developing a treatment plan using the protocol. This feature is disclosed in greater detail below.

Thus, the disclosed embodiments include a process that receives information, guidelines, rules and the like at platform 102. Using the program supported by platform 102, a veterinarian may develop a protocol 104. The veterinarian may check that actions comply with guidelines, rules, and the like. After protocol 104 is completed, it may be distributed to one or more of devices 110-114. Personnel may be trained using these devices along with protocol 104. The results of the training may be sent back to the veterinarian at platform 102. After the training is completed, protocol 104 is implemented at various operational stations on the farm, with results being stored. Further, a treatment plan 105 may be developed based on the results of protocol 104.

FIG. 3 illustrates a flowchart 300 for developing a protocol for a livestock operation according to the disclosed embodiments. The process disclosed by flowchart 300 may be used in performing step 202 above, but this step is not limited by the steps shown below. Flowchart 300 discloses the functions utilized in developing protocols for use in livestock management operations. As shown in FIG. 1, the development of the protocols takes into account residue and contamination issues with the livestock, so as to meet government guidelines and regulations for safety.

Step 302 executes by receiving such information at platform 102, as disclosed above. Examples of such information may be acceptable levels of residue within the meat and dairy produced by the livestock, or guidelines accepted by the industry on when/how much to administer to the livestock. While developing protocol 104, the veterinarian does not want to specify unsafe levels of pharmaceuticals that result in failed tests. Stored information on drugs, procedures and activities facilitate the building of protocol 104. Further, this information may be customized to suit the veterinarian's group. In other words, if the group relates to cows, then information regarding chickens is not provided to platform 102 and vice versa.

Veterinarians have the liberty to prescribe drugs to livestock in protocol 104 as needed, with a few exceptions. Drugs that are banned would not be included in relational database 106, and thus not available for use in building a protocol. Some drugs are allowed in certain classes of stock, but not in others, such as a drug that only can be used in dairy animals up to 20 months of age. There are many ways that this information may be reflected in the database information and made available to the veterinarian. The veterinarian, however, is still responsible for building the protocol. In some embodiments, non-veterinarians are able to build and manage protocols that do not involve prescription drugs.

In another embodiment, a link to an online Drug Compendium is made available to the veterinarian at any stage of the building process. Alternatively, a library of documents, such as PDFs, may be created for each drug in the compendium and stored on platform 102, database 106, or any other device. The library is made available whenever the program is in operation. Thus, the veterinarian may quickly check the regulations as he is building protocol 104. Veterinarians also have the incentive to make sure the protocols developed (which they “own”) do not violate any regulations.

The disclosed embodiments also may account for extra-label drug use in developing protocol 104. Extra-label drug use (ELDU) describes the use of an approved drug in a manner that is not in accordance with the approved labeling, yet meets the conditions set forth by the Animal Medicinal Drug Use Clarification Act of 1994 (AMDUCA) and U.S. Food and Drug Administration (FDA) regulations. Deviations from FDA-approved labeling include use in another species, use for a different indication, use at a different dose or frequency, and use via a different route of administration. If an action being taken is deemed ELDU, then protocol 104 also will be made extra-label. Thus, veterinarians will be alerted when such use occurs in one of their protocols.

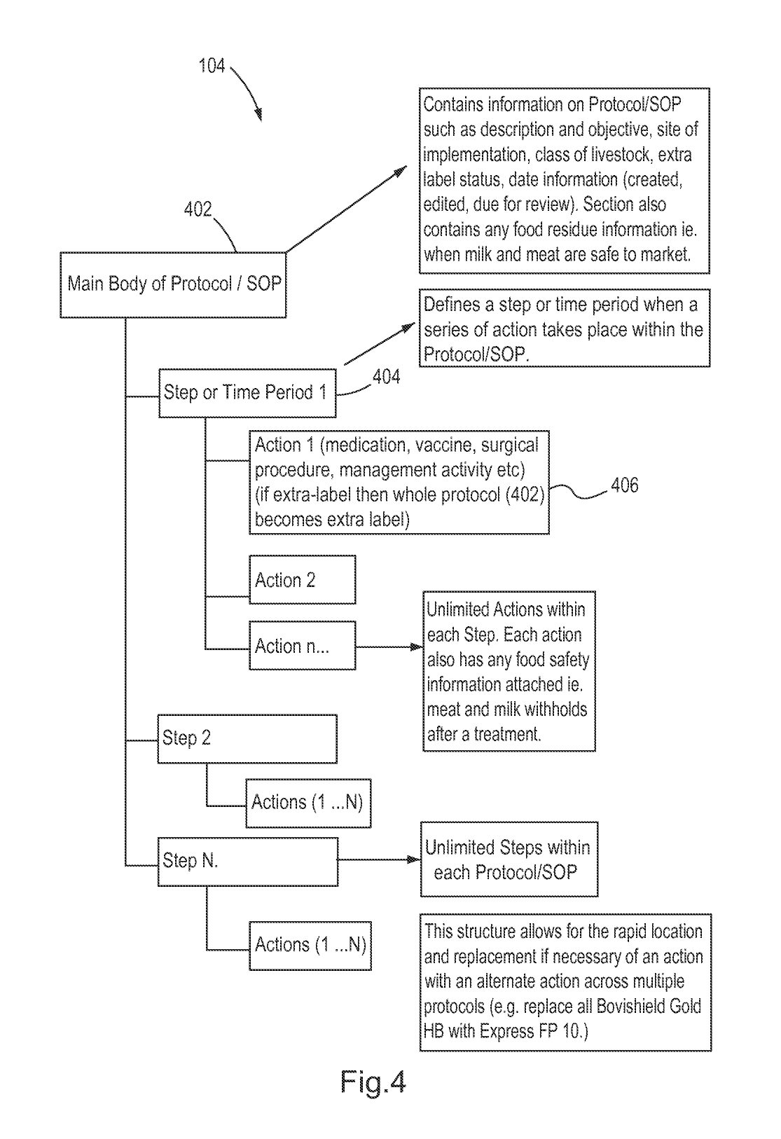

Step 304 execute by building protocol 104. Actions to be taken are selected by the veterinarian and added to protocol 104. An example protocol is disclosed in greater detail by FIG. 4. The veterinarian builds protocol 104 for a livestock operation with the help of a program stored on platform 102, and executed on processor 120. As the veterinarian selects steps or actions to be taken, the disclosed embodiments may compare the proposed steps against the received information to ensure regulations and guidelines are not violated. An action or step that may result in residue or contamination is flagged on the device, which then alerts the veterinarian. A protocol may have a general description about when a step is to be taken (as in FIG. 4) or alternatively, if a specified starting time is given, each step may be labeled with the precise time to apply. A treatment plan could employ one or more protocols with each step from different protocols arranged by time.

Step 306 executes by identifying protocol 104 to a single livestock operation. The protocol also is identified to a single veterinarian. This feature gives control of the actions in the protocol to the single veterinarian and is password protected. This feature also allows for tracking of the protocol and the administering veterinarian and operation in the event that violative residues occur. Protocols that result in possible contamination may be established by tracking them to specific operations and locations on the farm. Further, if variations of a protocol are used, then each operation gets one of the variations, and employs them in a treatment plan, so that the disclosed embodiments may identify which one is effective.

Step 308 executes by implementing, or administering, protocol 104. Once assigned to an operation within system 100, protocol 104 is implemented within the group of livestock associated with the operation. Step 310 executes by collecting information and results based on the actions outlined in the protocol. These results may be entered at the operation using the corresponding electronic device, and sent to platform 102 for use by the program. Step 312 executes by updating or modifying protocol 104 according to the results from the operation. At this point, the developed protocol may be re-administered if desired, and some of steps 304-310 repeated.

Step 314 executes by storing developed protocol 104 to a database within relational database 106. Step 316 executes by editing protocol 104, with access preferably limited to selected veterinarians. Thus, if protocol 104 is stored in program 1 of relational database 106, then only specified personnel may access it. Step 318 executes by storing information on training and compliance logs for each protocol in database 106.

Thus, after protocol 104 is built, steps and actions within the protocol are outlined for used by personnel in servicing animals within the farming community. This is distinguishable from implementing a protocol in a typical doctor's office. There, the patient is responsible for following the steps, along with the medical professional. The patient can indicate if the protocol fails or is feeling worse/better. In the present invention, the steps in a protocol must be developed by the professional, carried out by farm personnel and the results closely monitored by the professional. Protocols, therefore, should use a common format so that a variety of users can understand and follow the steps within a protocol. An example of a format may be shown in FIG. 4, which discloses a block diagram of a protocol.

The protocol shown in FIG. 4 relates to protocol 104 shown in FIG. 1. The structure shown allows a protocol to be flexible based on relational database principles. As noted above, a veterinarian develops protocol 104 using platform 102 for a livestock operation. Protocol 104 may be for an individual animal treatment, a group activity (medication or vaccination), or a non-treatment management activity (a welfare audit). Protocol 104 is stored within relational database with a unique identifier that associates it with the operation and the veterinarian. A non-veterinarian could be given access to develop protocols where the contained actions do not include scripted drugs or any off-label use of an ‘over the counter drug.’

FIG. 4 shows protocol 104 generated by platform 102. In this embodiment, protocol 104 includes three parts: a general section, steps or activity periods, and actions that occur within these periods. Protocol 104 also may include other sections.

General section, or main body, 402 may include overall information for the protocol. Such information may include the name of the protocol, dates created, last edits and when the protocol is due for a review. A description and objective also may be included. The assigned operation or location of the site of implementation may be included. General section 402 also may include whether the protocol involves the use of drugs in an extra label manner, as disclosed above. The protocol also includes the times to withhold meat and dairy products from human consumption after completion of the protocol. The protocol may also include time stamps that indicate precise times when actions should be performed. The originating veterinarian of the protocol determines whether the withdrawals for each of the entered actions is correct, and the disclosed process may also calculate suggested withholding times for the entire protocol. General section 402 may also include a notes or comment section in which any changes made to protocol 104 may be recorded. This information is automatically updated any time an action within the protocol is replaced.

Protocol 104 also includes steps, or time/activity periods, 404. To avoid confusion with the steps disclosed in the accompanying flowcharts, these features will be referred to as activity periods 404. An activity period 404 is a description of when a particular group of actions should occur within protocol 104. Each protocol may have an unlimited number of activity periods 404. The description of each activity period 404 may be customized within the disclosed processes.

Each activity period 404 includes one or more actions 406. Any number of actions may be within each activity period 404. Actions may be drug treatments, vaccinations, management procedures, surgical procedures, and the like. An action may be non-treatment in nature. If the action includes a drug treatment, then dairy and meat residue information is displayed for that action. Thus, the veterinarian can see the impact of each action on the overall protocol process.

Thus, protocol 104 is built by generating steps or activity periods, each having actions to be taken by personnel within the livestock operation. The actions seek to manage the medical treatment in an automated manner, while providing information and alerts to prevent residue or contamination of the by-products of the livestock operations. Further, the above structure allows for the rapid location and replacement of an action with an alternate action across multiple protocols. An example of a replacement may be substituting all Bovishield Gold HB (a vaccine) with Express FP 10 (another vaccine). Also should the residue information change on a given drug, all actions utilizing that drug can be quickly located and amended/updated. Using relational database 106, such a replacement may update all related protocols to reduce development time and potential oversights.

Using the steps and actions outlined in protocol 104, a veterinarian may instruct livestock care givers in the application of the protocol and record this training, as shown in step 206 of FIG. 2. This training includes attention to meat and dairy withholds. At a later date, the veterinarian may observe the application of the developed protocol and record the results for compliance review.

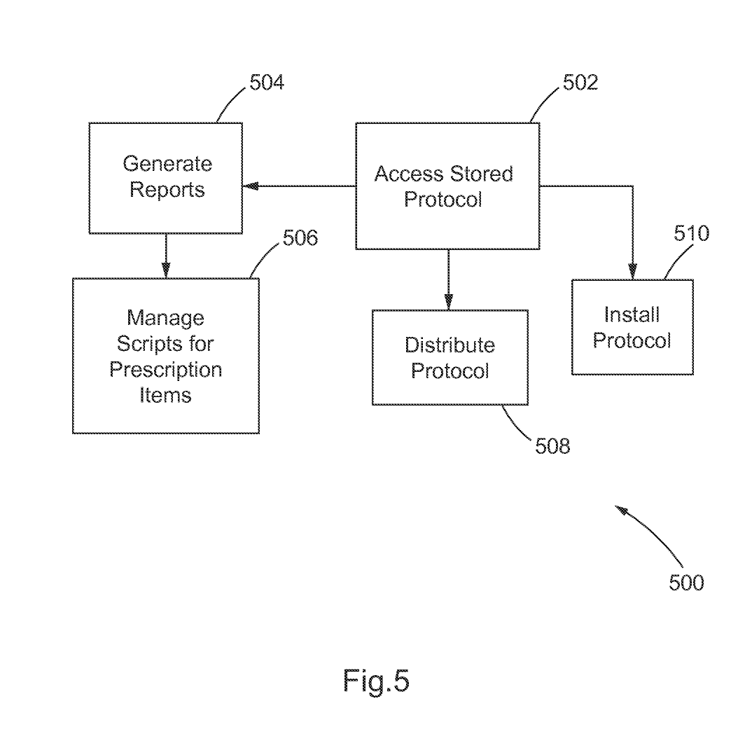

FIG. 5 illustrates a flowchart 500 for administering a protocol according to the disclosed embodiments. The process disclosed by flowchart 500 may be used in performing step 204 above, but this step is not limited by the steps described below. Step 502 executes by accessing the stored protocol 104 and any associated data. Step 504 executes by generating reports from the stored protocol data. Any number of reports may be stored and generated.

Step 506 executes by managing scripts for prescription items used in the protocols. The disclosed embodiments may track those prescription drugs used by the protocols and administered to the livestock during actions for the different operations. Each prescription is associated with a protocol, which is associated with an operation, as disclosed above. This feature allows the veterinarian to know what drugs have been given to what group of livestock, and any impact such administrations have on residue or contamination. In some embodiments, inventory (e.g., amounts of prescription drugs) may be tracked.

Step 508 executes by distributing a protocol to other entities, or end users, within system 100. For example, protocol 104 may be printed out and given to personnel at the different operations on the farm, or sent electronically (e.g., emailed) to devices 110-114. Protocol 104 also may be sent to other farms associated with the veterinarian, or other veterinarian/farm combinations. It also may be exported using the disclosed processes to other entities using the program. In other words, a developed protocol may be shared with any parties having authorization from the originating veterinarian. Step 510 executes by installing protocol 104 on a site associated with the livestock operations. This may be a view-only version that prevents users from modifying protocol 104 without permission of the originating veterinarian.

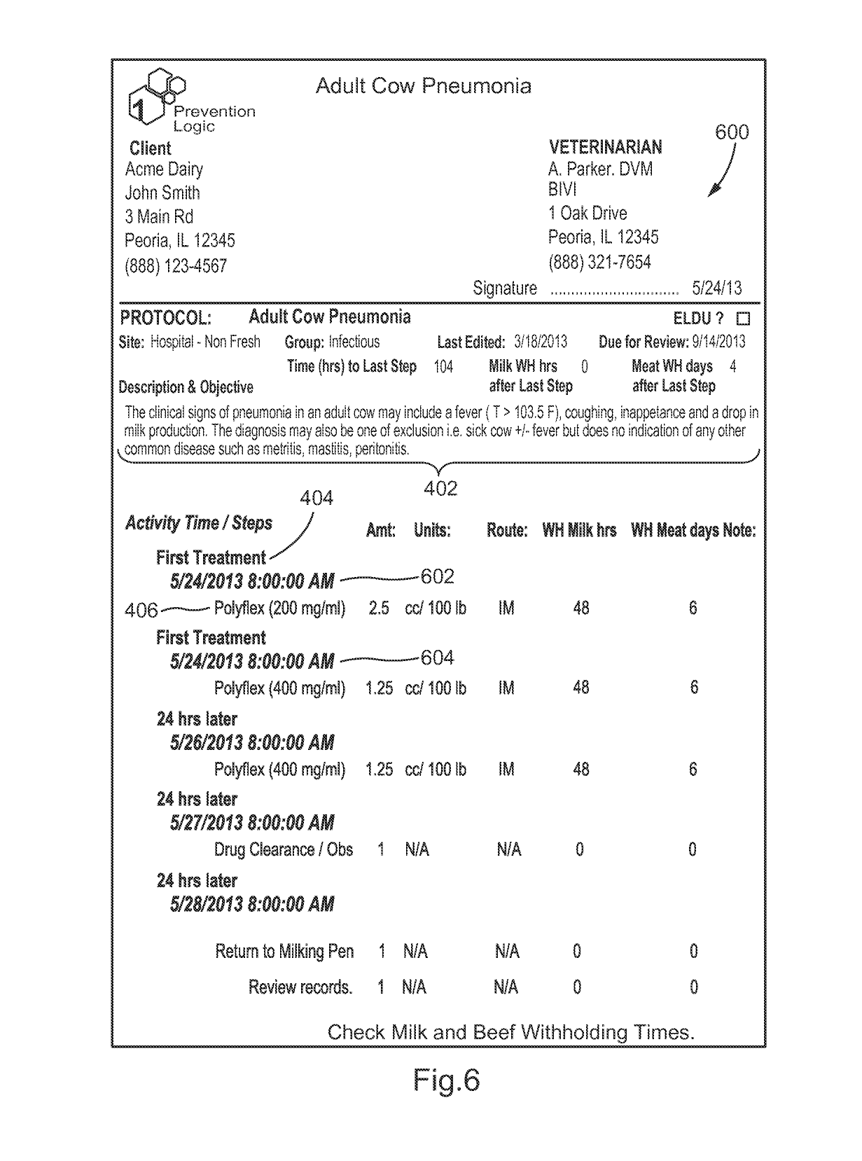

FIG. 6 depicts a treatment plan 600 according to the disclosed embodiments. Treatment plan 600 may be generated from protocol 104. Referring back to FIG. 4, the different features of protocol 104 are reflected in treatment plan 600. In this example, the protocol 104 pertains to adult cow pneumonia, and the actions are taken to treat the symptoms described in general section 402. In addition to a description and objective, edit and review dates are provided based on records associated with protocol 104. As the entries in database 106 are modified, this information is updated. Other information within general section 402 includes the site of the livestock operation and to what group that the cow belongs. Milking and meat withholding times refer to the number of hours or days that no dairy or meat should be taken from the treated cow.

Treatment plan 600 also includes steps or activity periods 404 listed below general section 402. Protocol 104 specifies an action 406 for each period. Timestamps, such as timestamps 602 and 604, may indicate the precise times to execute each action 406. For example, as shown in FIG. 6, a first treatment is given at 8 am and a second treatment given 24 hours later, also at 8 am. This provides times to personnel so that no confusion exists as to when to perform an action. Thus, treatment plan 600 lists an action 406 for each period, as well as the dairy and meat withholding times for each action. The first three periods include vaccination actions, while the last two periods have actions for observation and returning to the milking pen. The listing of actions by facilitates preventing the cow from being returned too early and minimizing a risk of providing milk for human consumption with residue. Thus, the impact of a protocol on times to hold livestock products from sale is captured in treatment plan 600.

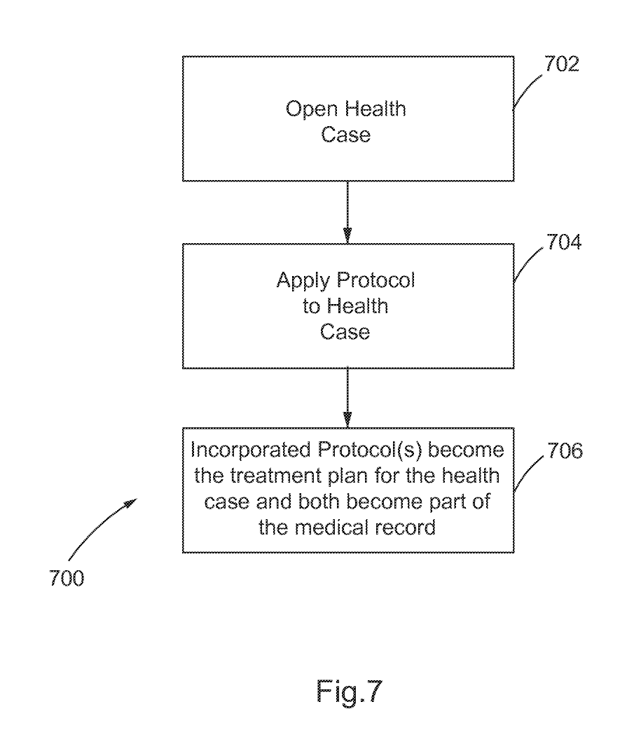

FIG. 7 illustrates a flowchart 700 for developing a treatment plan using a protocol according to the disclosed embodiments. Step 702 executes by opening a health case for a particular animal or a group of animals and a specific health condition. For example, a health case may be opened for cow Z having a lame front left leg. Another health case may be opened for the vaccination of all cows in pen 3 with Vaccine X. Each health case includes a starting time and an ending time in this embodiment.

Step 704 executes by applying a protocol, such as protocol 104, to each health case. After a health case is opened, a protocol or a plurality of protocols may be assigned based on the subject matter or area of interest. For example, a predetermined lameness treatment protocol may be applied for cow Z. When the protocol is integrated into the health case, the predetermined protocol is tied to particular times/dates and a particular animal ID. Further, if no protocol is available, a veterinarian may develop a protocol according the embodiments disclosed above to treat the conditions specified in the health case.

Step 706 executes by incorporating the protocol or protocols into a treatment plan, such as treatment plan 105. The assigned protocols, along with the health case, become part of the medical record for the treated animal(s). All of the functions may be performed in an automated manner so that the protocols are distributed quickly to stations at a farm to treat the opened health case, and then stored for future use.

Notably, once a protocol is generated using the embodiments described herein, the protocol may be cloned (i.e., replicated) for use by additional farms and/or for additional livestock. For example, if a veterinarian initially creates a protocol for cows at a first farm, and wants to create the same protocol for cows at a second farm, the veterinarian need only access the original protocol and change the farm identification information. Further, a second veterinarian can take the protocol generated by a first veterinarian and modify it (e.g., using drop down menus), as necessary, to address her needs. Accordingly, the systems and methods described herein facilitate easy and efficient creation and management of protocols. Further, in some embodiments, the systems and methods described herein may be utilized to track inventory related to protocols. For example, vaccine levels may be tracked using the embodiments described herein.

The disclosed embodiments may be supported and executed on a platform that has access to a network. The platform may support software and executable programs to provide the functionality disclosed above. For instance, the software may be deployed. Any software embodying the disclosed management protocol and its processes may be deployed by manually loading directly to the client, server and proxy computers via loading a storage medium such a CD, DVD, flash memory, chip, downloadable program and the like. The software also may be automatically or semi-automatically deployed into a computer system by sending the process software to a central server or a group of central servers. The software is downloaded into the client computers that execute the programs and instructions associated with the software.

Alternatively, the software may be sent directly to the client system via email. The software may be detached to a directory or loaded into a directory by a button on the email that executes a program that detaches the software into a directory. Another alternative is to send the software directly to a directory on the client computer hard drive. When there are proxy servers, the disclosed embodiments will select the proxy server code, determine on which computers to place the proxy servers' code, transmit the proxy server code, and install the proxy server code on the proxy computer. The software may be transmitted to the proxy server and then stored on the proxy server.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

In the context of this specification, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include plural forms as well, unless the context clearly indicates otherwise. It will be further understood that the terms “comprises” and/or “comprising,” when used in this specification, specific the presence of stated features, integers, steps, operations, elements, and/or components, but do not preclude the presence or addition of one or more other features, integers, steps, operation, elements, components, and/or groups thereof.

Embodiments may be implemented as a computer process, a computing system or as an article of manufacture such as a computer program product of computer readable media. The computer program product may be a computer storage medium readable by a computer system and encoding a computer program instructions for executing a computer process. When accessed, the instructions cause a processor to enable other components to perform the functions disclosed above.

The corresponding structures, material, acts, and equivalents of all means or steps plus function elements in the claims below are intended to include any structure, material or act for performing the function in combination with other claimed elements are specifically claimed. The description of the present invention has been presented for purposes of illustration and description, but is not intended to be exhaustive or limited to the invention in the form disclosed. Many modifications and variations will be apparent to those of ordinary skill without departing from the scope and spirit of the invention. The embodiment was chosen and described in order to best explain the principles of the invention and the practical application, and to enable others of ordinary skill in the art to understand the invention for embodiments with various modifications as are suited to the particular use contemplated.

One or more portions of the disclosed networks or systems may be distributed across one or more computer systems coupled to a network capable of exchanging information and data. These computer systems also may be general-purpose computer systems. Various functions and components of the computer system may be distributed across multiple client computer platforms, or configured to perform tasks as part of a distributed system. These components may be executable, intermediate or interpreted code that communicates over the network using a protocol. The components may have specified addresses or other designators to identify the components within the network.

It will be apparent to those skilled in the art that various modifications and variations can be made in the disclosed embodiments of the protocol management system without departing from the spirit or scope of the invention. Thus, it is intended that the present invention enables the modifications and variations of the embodiments disclosed above provided that they come within the scope of the claims and their equivalents.

What is claimed is:

1. A computer-implemented method for developing and managing a protocol for a livestock operation, the method comprising:
receiving, at a computing platform, input from a user;
generating, using the computing platform, the protocol based on the user input, wherein the protocol includes at least one activity period including at least one action; and
distributing the protocol to at least one end user.

2. The method of claim 1, further comprising storing the protocol in a relational database communicatively coupled to the computing platform.

3. The method of claim 1, wherein distributing the protocol comprises electronically distributing the protocol to at least one mobile device on a farm.

4. The method of claim 1, further comprising incorporating the protocol into one of a treatment plan and a medical record.

5. The method of claim 1, wherein generating the protocol comprises generating a protocol that includes a withholding time period associated with the at least one action.

6. The method of claim 1, further comprising calculating, using the computing platform, a recommended withholding time period associated with the at least one action.

7. The method of claim 1, further comprising receiving, at the computing platform, information regarding administration of the protocol by the end user.

8. The method of claim 1, wherein generating the protocol comprises generating a protocol that includes a time stamp indicating when the end user should perform the at least one action.

9. The method of claim 1, wherein generating the protocol comprises generating a protocol for the administration of a prescription drug to at least one animal.

10. The method of claim 9, wherein generating the protocol comprises generating a protocol for an extra-label drug use.

11. The method of claim 1, further comprising:
receiving, at the computing platform, additional information, wherein the additional information includes at least one of acceptable residue levels and industry guidelines; and
generating the protocol based on the additional information.

12. The method of claim 1, wherein receiving input from a user comprises receiving input from a veterinarian.

13. A platform for developing and managing a protocol for a livestock operation, the platform comprising:
a user interface configured to receive input from a user;
a processor coupled to the user interface and configured to:
generate the protocol based on the user input, wherein the protocol includes at least one activity period including at least one action; and
distribute the protocol to at least one end user.

14. The platform of claim 13, wherein the processor is configured to store the protocol in a relational database communicatively coupled to the platform.

15. The platform of claim 13, wherein the processor is configured to electronically distribute the protocol to at least one mobile device on a farm.

16. The platform of claim 13, wherein the processor is configured to incorporate the protocol into one of a treatment plan and a medical record.

17. The platform of claim 13, wherein to generate the protocol, the processor is configured to generate a protocol that includes a withholding time period associated with the at least one action.

18. The platform of claim 13, wherein to generate the protocol, the processor is configured to generate a protocol that includes a time stamp indicating when the end user should perform the at least one action.

19. The platform of claim 13, wherein to generate the protocol, the processor is configured to generate a protocol for the administration of a prescription drug to at least one animal.

20. The platform of claim 13, wherein the user interface is configured to receive input from a veterinarian.
